(19) United States
(12) Patent Application Publication
(10) Pub. No.: US 2011/0261029 A1
(43) Pub. Date: Oct. 27, 2011

(54) APPARATUS AND METHOD FOR DRIVING LIQUID CRYSTAL DISPLAY DEVICE

(76) Inventors: Myung Kook MOON, Daegu (KR); Hyun Taek NAM, Daegu (KR); Sung Jo KOO, Gyeonggi-do (KR); Jong Woo KIM, Gyeongsangbuk-do (KR)

(21) Appl. No.: 12/962,769

(22) Filed: Dec. 8, 2010

(30) Foreign Application Priority Data
Apr. 21, 2010 (KR) 10-2010-0036724

(51) Int. Cl. G06F 3/038

(52) U.S. Cl. 345/204; 345/87

(57) ABSTRACT

Disclosed is an apparatus for driving an LCD device displaying 2D image, and 3D image through the use of shutter glass comprising: a lookup table part including a 3D lookup table for generating 3D overdriving data to be reflected in 3D image data, and a 2D lookup table for generating 2D overdriving data to be reflected in 2D image data; a lookup table selecting part for selecting the 2D lookup table or 3D lookup table provided from the lookup table part according to 2D or 3D mode input; an ODC data generating part for generating the 2D overdriving data to be reflected in the 2D image, and the 3D overdriving data to be reflected in the 3D image according to 2D or 3D mode input; and a shutter glass controlling part for controlling an operation of shutter glass so that a user recognizes an image displayed on a liquid crystal panel as the 3D image.

### CROSS REFERENCE TO RELATED APPLICATIONS

This application claims the benefit of the Korean Patent Application No. 10-2010-0036724 filed on Apr. 21, 2010, which is hereby incorporated by reference as if fully set forth herein.

### BACKGROUND OF THE INVENTION

1. Field of the Invention

The present invention relates to a liquid crystal display (LCD) device, and more particularly, to an apparatus and method for driving an LCD device.

2. Discussion of the Related Art

An LCD device includes a liquid crystal panel on which plural liquid crystal cells are arranged in a matrix-type configuration; and a driving circuit for driving the liquid crystal panel. The LCD device displays a desired image by controlling a transmittance for each of the liquid crystal cells according to an input video signal.

On the liquid crystal display panel, there are the plural liquid crystal cells defined by crossing a plurality of gate lines and a plurality of data lines at right angles. Each liquid crystal cell is provided with pixel electrode and common electrode for applying an electric field. Each of the liquid crystal cells is switched through a thin film transistor (TFT).

The driving circuit includes a gate driver (G-IC) for supplying a scan signal to the gate lines; a data driver (D-IC) for supplying a data voltage based on an image signal to the data lines; a timing controller for supplying a control signal to the gate driver and data driver, and supplying image data to the data driver; and a backlight driver for driving a light source (backlight) supplying light to the liquid crystal panel.

In each liquid crystal cell of the LCD device, an alignment of liquid crystal is changed based on the electric field formed between the pixel electrode and common electrode. The transmittance of light supplied from the backlight unit can be controlled through the alignment of liquid crystal, to thereby display the image.

Recently, a user's demand for a stereoscopic image is rapidly increased so that an LCD device capable of displaying 3D (3-dimensional) image as well as 2D (2-dimensional) image is actively developed. The LCD device displaying 3D image can realize the 3D image through a difference in viewing between both eyes of the user (binocular display). There have been proposed a shutter glass method using stereoscopic glasses, a patterned retarder method using polarizing glasses, and a lenticular lens method.

FIGS. 1 and 2 illustrate a method of realizing 3D image by a related art shutter glass method.

Referring to FIGS. 1 and 2, the method of realizing 3D image by the related art shutter glass method uses a difference in viewing between both eyes of the user through the use of shutter glass 20. After 2D left-eye image and 2D right-eye image, which are different from each other, are viewed by the left and right eyes of the user, two of the 2D images are integrated, whereby the integrated image is perceived as the 3D image by the user.

For this, a liquid crystal panel 10 separately displays 2D images for the left-eye viewing and right-eye viewing with a difference in time. Through the use of shutter glass 20, the right-eye viewing is intercepted and the 2D image is viewed by the left eye when the 2D image for the left-eye viewing is displayed on the liquid crystal panel 10; and the left-eye viewing is intercepted and the 2D image is viewed by the right eye when the 2D image for the right-eye viewing is displayed on the liquid crystal panel 10. Thus, after the different 2D images are respectively viewed by the left eye and the right eye with the different in time, the viewed 2D images are integrated so that the integrated image is perceived as the 3D image by the user.

If the 3D image is realized through the use of shutter glass 20 in the related art LCD device, as shown in FIG. 2, the 2D images for the left-eye viewing and right-eye viewing are alternately displayed for a preset time period (1 frame).

However, if a response speed of liquid crystal is slow, liquid crystal behavior is not completed for the preset time period. In this case, the left-eye image and right-eye image are overlapped without completely separating from each other, that is, crosstalk occurs. That is, the two 2D images of the left-eye image and right-eye image are displayed while being overlapped.

Referring to FIG. 3, according as the scan signal is sequentially applied to the plural gate lines of the liquid crystal panel 10, the thin film transistor (TFT) is turned-on, whereby the response speed is the lowest in a lower region of the liquid crystal panel 10. Thus, if the 3D image is displayed for a blank time through the use of shutter glass 20, a crosstalk rate in the lower region of the liquid crystal panel 10 becomes large for an initial period of turning on the shutter glass 20.

Like the liquid crystal panel 10, the shutter glass 20 is turned on/off through the liquid crystal, whereby a response speed of the shutter glass 20 is also slow. Thus, even though the shutter glass 20 is turned-off at an end point of vertical blank time (V-Blank), the shutter glass 20 is not completely closed until image data of an upper region of the liquid crystal panel 10 is displayed. At a point of turning off the shutter glass 20, a crosstalk rate in the upper region of the liquid crystal panel 10 becomes large, whereby the two 2D images of the left-eye image and right-eye image are displayed while being overlapped.

As mentioned above, the related art LCD device realizing the 3D image through the use of shutter glass 20 is disadvantageous in that the picture quality of the 3D image is deteriorated due to the response speed of liquid crystal in the liquid crystal panel 10 and the response speed property of the shutter glass 20.

For providing the 3D image with high picture quality to the user by decreasing the crosstalk, the response speed of liquid crystal should be improved. For this, the related art 3D LCD device supplies the image data to the liquid crystal panel 10 by applying an overdriving method (ODC), to thereby improve the response speed of liquid crystal.

According to the related art, the overdriving rate of image data is set with respect to the central region of the liquid crystal panel 10. Thus, the crosstalk rate in the central region of the liquid crystal panel 10 is acceptable.

However, the crosstalk in the upper and lower regions of the liquid crystal panel 10 becomes serious due to an addressing order of the image data and the slow response speed of the shutter glass 20, so that the picture quality of the 3D image is deteriorated.

Meanwhile, if the overdriving rate is set with respect to the upper and lower regions of the liquid crystal panel 10, the crosstalk may be considerably decreased in the upper and lower regions of the liquid crystal panel 10. However, the crosstalk becomes worsen in the central region of the liquid crystal panel 10, whereby the picture quality of the 3D image is deteriorated.

FIG. 4 illustrates a method for measuring crosstalk in the related art LCD device. FIGS. 5 to 7 illustrate crosstalk measurement result for each luminance in the related art LCD device.

As shown in FIG. 4, the left-eye image with ‘i’ luminance (gray) and the right-eye image with ‘j’ luminance (gray) are alternately displayed on the liquid crystal panel 10; and the luminance values of the left-eye image and right-eye image viewed through the shutter glass 20 are measured.

The measured luminance values of the left-eye image and right-eye image are applied to the following equation 1, and the crosstalk rate for each luminance is calculated, as shown in FIGS. 5 to 7. Thus, the average of the crosstalk rate for each luminance is calculated. At this time, the luminance of the image displayed on the liquid crystal panel 10 may be changed to 64 gray unit (0gray [symbol] 63gray, 64 [symbol] 127, •••).

$$CTi , j = \frac{( Gi , j - Gj , i )}{( Gj , i + Gi , j )} \times 100 \% \qquad [ Equation 1 ]$$

In the above equation 1, ‘Gi,j’ indicates the luminance value when ‘i’ gray is changed to ‘j’ gray; ‘Gj,i’ indicates the luminance value when ‘j’ gray is changed to ‘i’ gray; and the ‘CTi,j’ indicates the crosstalk rate according to the luminance.

According to the measurement result, the average crosstalk rate in the central region of the liquid crystal panel 10 is 2.23; the average crosstalk rate in the upper region of the liquid crystal panel 10 is 4.22; and the average crosstalk rate in the lower part of the liquid crystal panel 10 is 7.87.

As mentioned above, in case of the related art 3D LCD device, the overdriving rate of the image data is set with respect to the central region of the liquid crystal panel 10. Thus, the crosstalk in the central region of the liquid crystal panel 10 is acceptable, but the crosstalk in the upper and lower regions of the liquid crystal panel 10 occurs seriously, whereby the picture quality of the 3D image is deteriorated. Especially, the crosstalk in the lower region of the liquid crystal panel 10 is worse so that the user can not perceive the 3D image.

### SUMMARY OF THE INVENTION

Accordingly, the present invention is directed to an apparatus and method for driving an LCD device that substantially obviates one or more problems due to limitations and disadvantages of the related art.

An advantage of the present invention is to provide an apparatus and method for driving an LCD device, which facilitate to improve picture quality of 3D image.

Another advantage of the present invention is to provide an apparatus and method for driving an LCD device, which facilitate to realize a rapid response speed of liquid crystal by respectively applying different overdriving rates to plural local regions obtained by dividing a display area of a liquid crystal panel.

Another advantage of the present invention is to provide an apparatus and method for driving an LCD device, which facilitate to lower crosstalk rate of 3D image by improving a response speed of liquid crystal.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, there is provided an apparatus for driving an LCD device displaying 2D image, and 3D image through the use of shutter glass comprising: a lookup table part including a 3D lookup table for generating 3D overdriving data to be reflected in 3D image data, and a 2D lookup table for generating 2D overdriving data to be reflected in 2D image data; a lookup table selecting part for selecting the 2D lookup table or 3D lookup table provided from the lookup table part according to 2D or 3D mode input; an ODC data generating part for generating the 2D overdriving data to be reflected in the 2D image, and the 3D overdriving data to be reflected in the 3D image according to 2D or 3D mode input; and a shutter glass controlling part for controlling an operation of shutter glass so that a user recognizes an image displayed on a liquid crystal panel as the 3D image.

At this time, the 3D lookup table comprises plural lookup tables to divide an entire display area into plural local regions and to apply the different lookup table values to the respective local regions.

The ODC data generating part generates the 2D overdriving data for the 2D image through the use of 2D lookup table according to the 2D mode input, and provides the 3D overdriving data for the 3D image through the use of 3D lookup table according to the 3D mode input.

Also, the ODC data generating part generates a plurality of 3D overdriving data to divide an entire display area of liquid crystal panel into plural local regions and to apply an overdriving rate to each of the respective local regions.

In another aspect of the present invention, there is provided a method for driving an LCD device displaying 2D image and 3D image through the use of shutter glass comprising: generating 2D overdriving data for the 2D image through the use of 2D lookup table, or generating 3D overdriving data for the 3D image through the use of 3D lookup table, according to 2D mode or 3D mode input; reflecting the 2D overdriving data or 3D overdriving data in image data aligned by each frame unit; and displaying the 2D image or 3D image by supplying a liquid crystal panel with an analog data signal according to the image data in which the 2D overdriving data or 3D overdriving data is reflected.

At this time, the 3D image is displayed by dividing a display area of the liquid crystal panel into plural local regions, and applying the different overdriving rates to the respective local regions.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1 and 2 illustrate a method for displaying a 3D image in a related art shutter glass method;

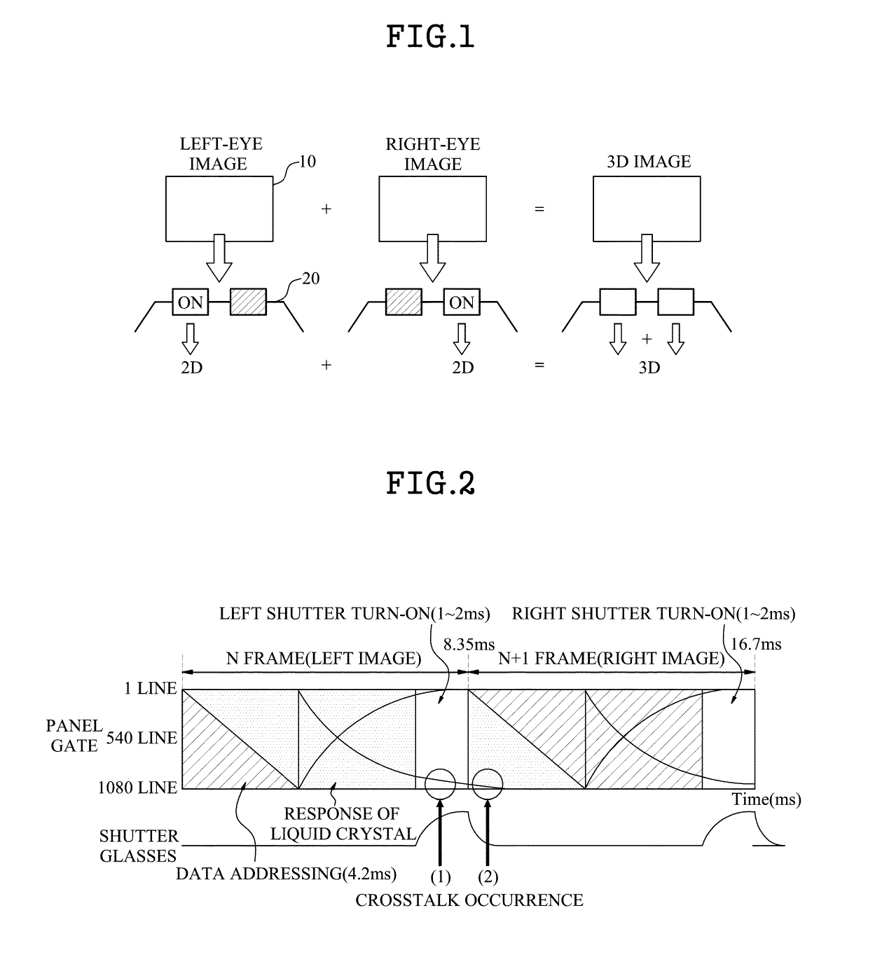

FIG. 3 illustrates a crosstalk occurrence for each region of a liquid crystal panel when displaying a 3D image;

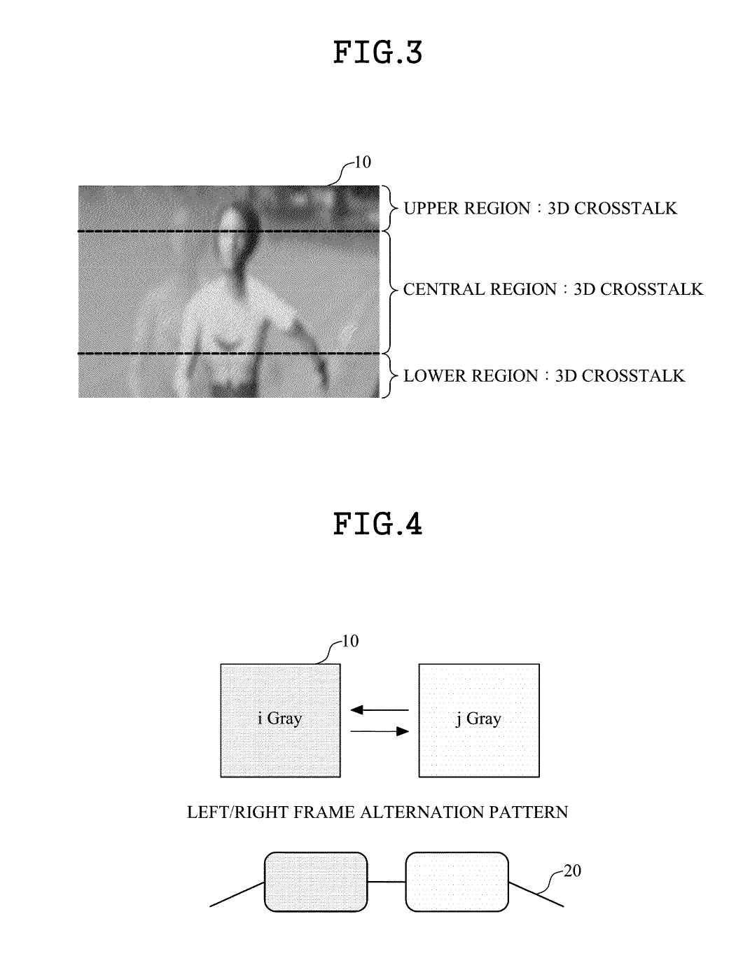

FIG. 4 illustrates a method for measuring crosstalk in a related art LCD device;

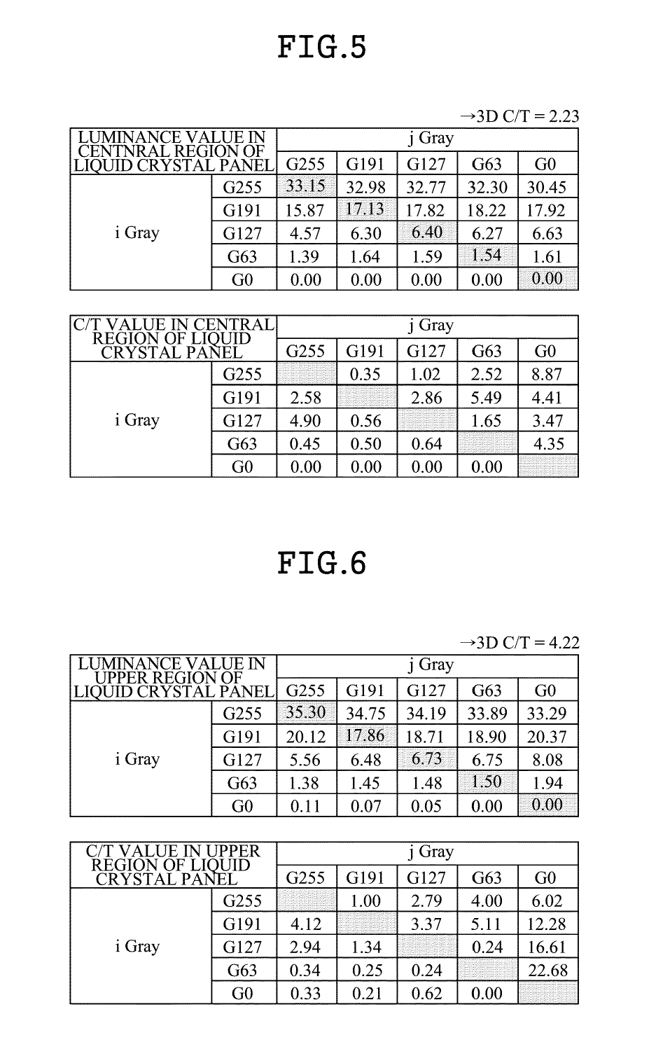

FIGS. 5 to 7 illustrate crosstalk measurement result for each luminance in the related art LCD device;

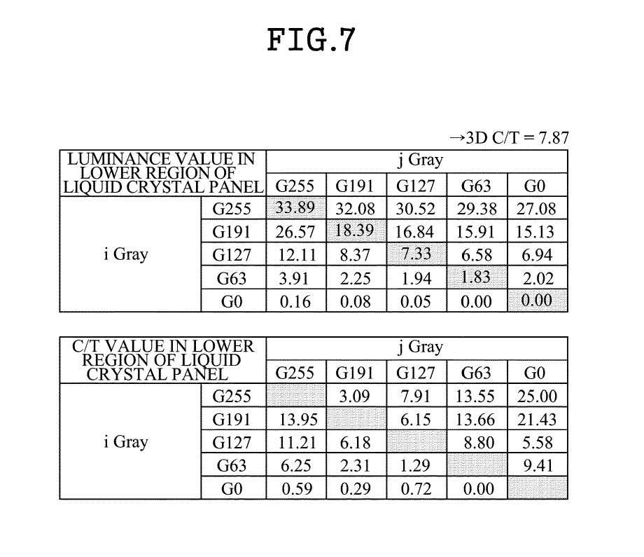

FIG. 8 illustrates an LCD device with an overdriving controller according to the embodiment of the present invention;

FIG. 9 illustrates an overdriving controller according to the embodiment of the present invention;

FIGS. 10 to 12 illustrate a local overdriving method according to the embodiment of the present invention;

FIGS. 13 to 15 are tables showing crosstalk measurement results by each luminance according to the embodiment of the present invention; and

FIG. 16 is a table comparing the crosstalk occurrence rate of the present invention with the crosstalk occurrence rate of the related art.

### DETAILED DESCRIPTION OF THE INVENTION

Reference will now be made in detail to the exemplary embodiments of the present invention, examples of which are illustrated in the accompanying drawings. Wherever possible, the same reference numbers will be used throughout the drawings to refer to the same or like parts.

Hereinafter, an apparatus and method for driving an LCD device according to the present invention will be described with reference to the accompanying drawings.

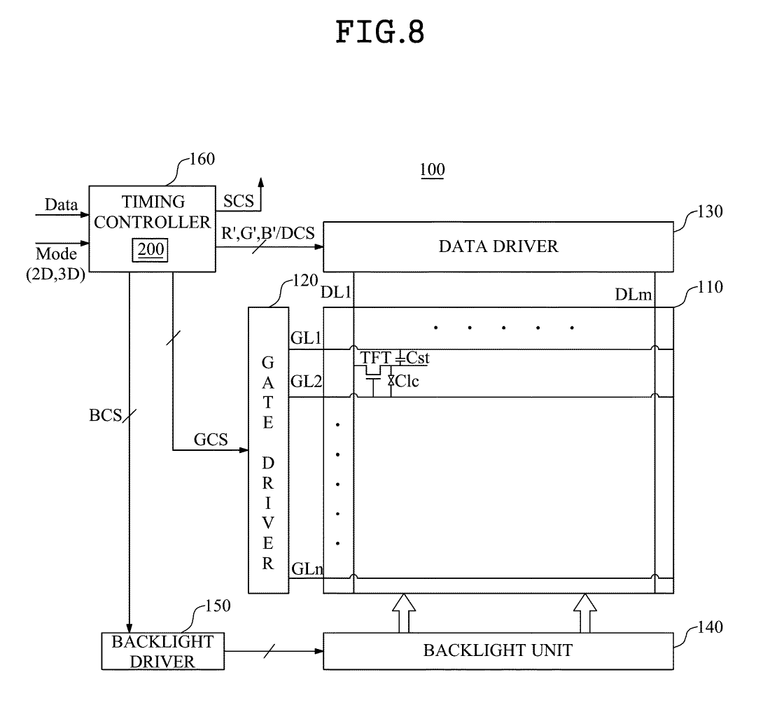

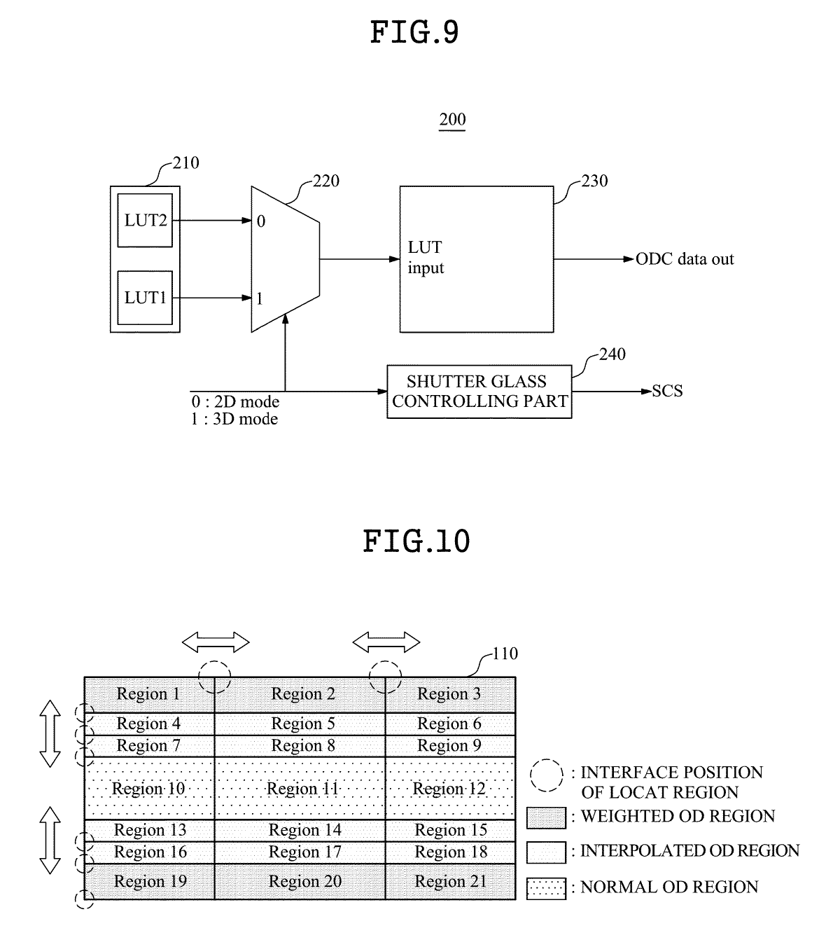

FIG. 8 illustrates an LCD device to which an apparatus for driving an LCD device according to the embodiment of the present invention is applied. FIG. 9 illustrates an apparatus for driving an LCD device according to the embodiment of the present invention.

Referring to FIGS. 8 and 9, an LCD device 100, to which an overdriving controller 200 according to the embodiment of the present invention is applied, includes a liquid crystal panel 110, a gate driver 120, a data driver 130, a backlight unit 140, a backlight driver 150, and a timing controller 160. At this time, the overdriving controller 200 may be formed in the timing controller 160.

The liquid crystal panel 110 includes plural gate lines (G1 to Gn) and plural data lines (D1 to Dm); and liquid crystal cells (Clc, pixel region) formed by crossing the plural gate lines (G1 to Gn) and data lines (D1 to Dm) at right angles. Each of the liquid crystal cells includes a thin film transistor (TFT) and a storage capacitor (Cst), wherein the thin film transistor (TFT) is formed adjacent to a crossing portion of the gate and data lines.

In response to a scan signal supplied from the gate lines, the thin film transistor (TFT) supplies an analog data signal (data voltage) supplied from the data lines to the liquid crystal cell.

The liquid crystal panel 110 cannot emit light in itself. Thus, light emitted from the backlight unit 140 is supplied to the liquid crystal panel 110.

The backlight unit 140 is provided to emit the light to the liquid crystal panel 110. The backlight unit 140 includes plural light sources for generating light, for example, cold cathode fluorescent lamp (CCFL), external electrode fluorescent lamp (EEFL), light-emitting diode (LED), and etc. In addition, the backlight unit 140 includes optical members (light-guiding plate, light-diffusion plate, optical sheets, and etc.) for guiding the light emitted from the light source to the liquid crystal panel 110, and simultaneously improving light efficiency.

The backlight driver 150 drives the light source according to a backlight control signal (BCS) inputted from the timing controller 160. At this time, the backlight driver 150 can control luminance of the light source so as to realize a high resolution of image displayed on the liquid crystal panel 110 according to the backlight control signal (BCS).

The gate driver 120 generates the scan signal for driving the thin film transistor (TFT) in each liquid crystal cell on the basis of a gate control signal (GCS) supplied from the timing controller 130; and then sequentially supplies the generated scan signal to the gate lines (G1 to Gn) of the liquid crystal panel 110, to thereby drive the thin film transistor (TFT).

The data driver 130 converts digital image data (R′, G′, B′) supplied from the timing controller 160 to the analog data signal (data voltage). The converted analog data signal is supplied to the data lines in response to a data control signal (DCS) supplied from the timing controller 160.

At this time, overdriving data supplied from an overdriving controller 200 to be explained is reflected in the digital image data (R′, G′, B′) provided from the timing controller 160 to the data driver 130.

The timing controller 160 generates the gate control signal (GCS) for controlling the gate driver 120 through the use of vertical/horizontal synchronous signal and clock signal; and the data control signal (DCS) for controlling the data driver 130. Also, the timing controller 160 generates the backlight control signal (BCS) for controlling the backlight driver 150.

The generated gate control signal (GCS) is supplied to the gate driver 120; the generated data control signal (DCS) is supplied to the data driver 130; and the backlight control signal (BCS) is supplied to the backlight driver 150.

At this time, the data control signal (DCS) may include a source start pulse (SSP), a source sampling clock (SSC), a source output enable (SOE), and a polarity control signal (POL).

The gate control signal (GCS) may include a gate start pulse (GSP), a gate shift clock (GSC), and a gate output enable (GOE).

Also, the timing controller 160 aligns externally-provided image signals, converts the aligned image signals to digital image data (R, G, B) by frame unit; reflects the overdriving data supplied from the overdriving controller 200 in the digital image data aligned by frame unit; and supplies the digital image data, in which the overdriving data is reflected, to the data driver 120.

For improving a response speed of liquid crystal, the overdriving controller 200 according to the embodiment of the present invention generates the overdriving data (ODC data) reflected in the digital image data (R, G, B) aligned in the timing controller 160 according to 2D mode or 3D mode input.

If the desired image to be displayed corresponds to the 3D image, the overdriving controller 200 generates a shutter glass control signal (SCS) for controlling shutter glass according to the 3D mode input; and provides the generated shutter glass control signal (SCS) to the timing controller 160.

For this, the overdriving controller 200 includes a lookup table part 210, a lookup table selecting part 220, an ODC data generating part 230, and a shutter glass controlling part 240, as shown in FIG. 9.

The lookup table part 210 may be formed of a non-volatile memory such as EEPROM (Electrically Erasable Programmable Read-Only Memory). The lookup table part 210 includes a 3D lookup table (LUT1) for generating 3D overdriving data, and a 2D lookup table (LUT2) for generating 2D overdriving data.

As mentioned above, if an overdriving rate is set on the basis of a central region of the liquid crystal panel, crosstalk occurrences become more serious in lower and upper regions of the liquid crystal panel. Also, if only one driving rate is applied without classifying the 2D image and 3D image, it is difficult to satisfy picture quality of the 2D image and 3D image.

For example, if the overdriving rate set on the basis of the 3D image data is applied on displaying the 2D image, it is difficult to sequentially display the images in the lower and upper regions of a screen, whereby the picture quality of the 2D image may be deteriorated.

In order to overcome this problem, the overdriving controller 200 according to the embodiment of the present invention includes the 3D lookup table (LUT1) for the 3D image, and the 2D lookup table (LUT2) for the 2D image.

At this time, the 2D lookup table (LUT2) may comprise one 2D lookup table to apply the same lookup table value to the entire regions of the liquid crystal panel 110.

The 3D lookup table (LUT1) may comprise plural 3D lookup tables to divide the entire display area into plural local regions, and to apply the different lookup table values to the respective local regions.

At this time, preset values are stored in the 3D lookup table (LUT1) and 2D lookup table (LUT2), wherein the preset values are provided to set the overdriving rate reflected in the 3D/2D image data according to a luminance value of 3D/2D image.

The preset values stored in the 3D lookup table (LUT1) and 2D lookup table (LUT2) may be changeable according to the property of the liquid crystal panel 110, that is, quality of the desirable image to be displayed.

The lookup table selecting part 220 selects the 3D lookup table (LUT1) or 2D lookup table (LUT2) provided from the lookup table part 210 according to the 2D mode or 3D mode input; and provides the selected one to the ODC data generating part 230. That is, if the 2D mode is inputted, the lookup table selecting part 200 selects the 2D lookup table (LUT2) so as to generate the 2D overdriving data of the 2D mode in the ODC data generating part 230. Meanwhile, if the 3D mode is inputted, the lookup table selecting part 200 selects the 3D lookup table (LUT1) so as to generate the 3D overdriving data of the 3D mode in the ODC data generating part 230.

In order to lower the crosstalk occurrence level when the 2D or 3D image is displayed on the liquid crystal panel 110, the ODC data generating part 230 generates the overdriving data to be reflected in the 2D image or 3D image according to the 2D mode or 3D mode input; and provides the generated overdriving data to the timing controller 160.

If the 2D mode is inputted, the 2D overdriving data is generated through the use of 2D lookup table (LUT2) inputted via the lookup table selecting part 220. Then, the generated 2D overdriving data is provided to the timing controller 160.

If the 3D mode is inputted, the 3D overdriving data is generated through the use of 3D lookup table (LUT1) inputted via the lookup table selecting part 220. Then, the generated 3D overdriving data is provided to the timing controller 160.

If the 3D image is displayed on the liquid crystal panel 110 according to the 3D mode input, the overdriving rate for the 3D image is reflected in the image data (data voltage), and is supplied to each pixel of the liquid crystal panel 110, so that the crosstalk occurrence level is lowered owing to the rapid response speed of liquid crystal.

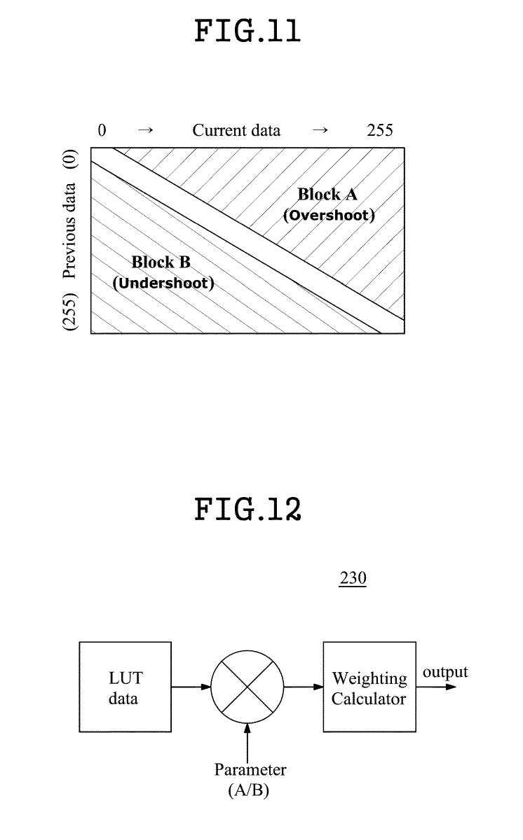

Referring to FIGS. 10 to 12, when generating the 3D overdriving data for the 3D image, the ODC data generating part 230 divides the entire display area of the liquid crystal panel 110 into the plural local regions; and generates the plurality of 3D overdriving data to respectively apply the overdriving rate to each of the local regions.

At this time, if the same overdriving rate is applied to the entire display area of the liquid crystal panel 110, the crosstalk occurrence level becomes different among the central region, upper region and lower region of the screen.

For lowering the crosstalk occurrence level, the entire display area of the liquid crystal panel 110 is divided into the plural local regions (for example, 21 local regions), as shown in FIG. 10. Then, the overdriving rate is differently applied to the respective local regions, so that it is possible to lower the crosstalk occurrence level which affects the picture quality of 3D image.

At this time, the size and number of the plural local regions may be variable programmably. The aforementioned embodiment of the present invention discloses that the entire display area is divided into the 21 local regions.

The plural local regions may be classified into 3 blocks, that is, the central block (region 10˜region 12), the upper/lower block (region 1˜region 3, region 19˜region 21), and the interpolated block (region 4˜region 9, region 13˜region 18) between the lower and upper blocks. Hereinafter, the central block is referred to as the first block; the interpolated block is referred to as the second block; and the upper/lower block is referred to as the third block.

A grayscale of the image displayed on the liquid crystal panel 110 may be variable from a low grayscale (0 gray) to a high grayscale (255 gray). In this case, the overdriving rates applied to the first to third blocks can be calculated through the following equations 2 and 3.

As shown in FIG. 11, in order to realize the rapid response speed of liquid crystal according to the grayscale value of the image, the overdriving rate can be calculated by separately applying parameters for overshoot and undershoot.

$$\begin{matrix}{LUT}_{weighted} = input\_data + \frac{A}{B} \times ( L U T - input\_data ) & [ Equation 2 ] \\ {LUT}_{weighted} = input\_data - \frac{{A}^{′}}{{B}^{′}} \times ( input\_data - L U T ) & [ Equation 3 ]\end{matrix}$$

At this time, the equation 2 is to calculate the overdriving rate for over-driving; and the equation 3 is to calculate the overdriving rate for under-driving.

In the above equation 2 and equation 3, ‘LUT’ indicates the 3D lookup table (LUT1) for the 3D image; and ‘Input_data’ indicates the input 3D image data signal. Also, the overdriving rate (weighting value) to be reflected in the 3D image data is differently set to the overshoot (application of the A and B parameters) and undershoot (application of the A′ and B′ parameters). The A parameter, B parameter, A′ parameter, and B′ parameter have integer values of 0˜255.

As shown in FIG. 12, the overdriving rate can be calculated by separately applying the respective parameters (A parameter, B parameter, A′ parameter, B′ parameter) to the 3D lookup table (LUT1) data. Thus, the ODC data generating part 230 generates the plurality of 3D overdriving data of the 3D image for each of the respective first, second, and third blocks.

In more detail, the first block corresponding to the central block (region 10˜region 12) of the liquid crystal panel 110 is a normal overdriving region (Normal OD region) whose crosstalk occurrence level is relatively low. Thus, the lowest overdriving rate, that is, first overdriving rate is applied to the first block.

Then, a second overdriving rate which is slightly larger than the first overdriving rate is applied to the interpolated block (region 4˜region 9, region 13˜region 21) interpolated between the upper and lower blocks of the liquid crystal panel 110, to thereby minimize discontinuity of the image displayed between the central block and the upper/lower blocks.

A third overdriving rate, that is, the highest overdriving rate is applied to the third block corresponding to the upper/lower block (region 1˜region 3, region 19˜region 21) of the liquid crystal panel 110, so that it is possible to shorten the response time of liquid crystal, as compared to the central block of the liquid crystal panel 110.

At this time, the first to third overdriving rates apply the A parameter, B parameter, A′ parameter, and B′ parameter, so that the overdriving rates for undershoot and overshoot are applied.

The aforementioned embodiment of the present invention discloses that the plurality of 3D overdriving data for the 3D image is generated for each of the first to third blocks, but not necessarily. According to another example, the plurality of 3D overdriving data may be generated for each of the plural local regions. Thus, the different overdriving rates may be applied for each of the plural local regions.

The shutter glass controlling part 240 generates the shutter glass control signal (SCS) for an operation control of the shutter glass so that the user recognizes the image displayed on the liquid crystal panel 110 as the 3D image on the basis of the 3D mode input. Also, the shutter glass control signal (SCS) can be provided to the shutter glass via a transmission means (wire means or wireless means) which is not shown, to thereby control the operation of shutter glass.

At this time, the shutter glass is driven according to the shutter glass control signal (SCS) so that the user recognizes the image displayed on the liquid crystal panel 110 as the 3D image.

In the aforementioned explanation, the overdriving controller 200 is formed in the timing controller 160, but not necessarily. According to another embodiment of the present invention, the overdriving controller 200 may be formed as an individual unit in the LCD device 100.

The overdriving controller 200 with the aforementioned structure according to the embodiment of the present invention divides the display area into the plural local regions; and differently applies the local overdriving to each of the plural local regions, to thereby realize the high response speed of liquid crystal. Accordingly, the crosstalk occurrence level is lowered in the central region, upper/lower region, and the region between the central region and the upper/lower region on the liquid crystal panel 100, to thereby improve the picture quality of 3D image.

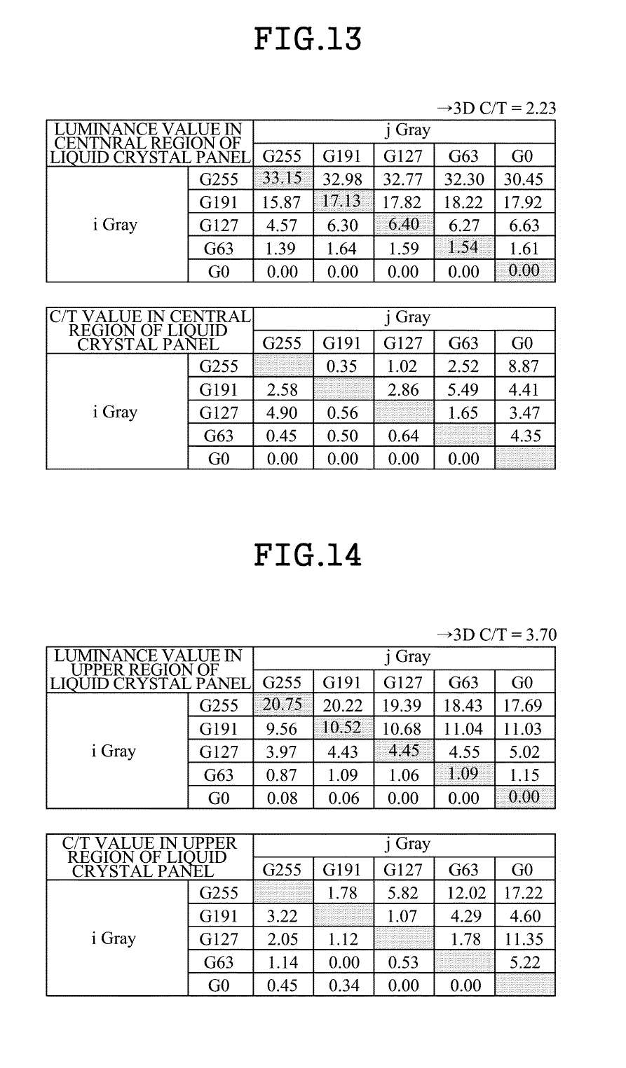

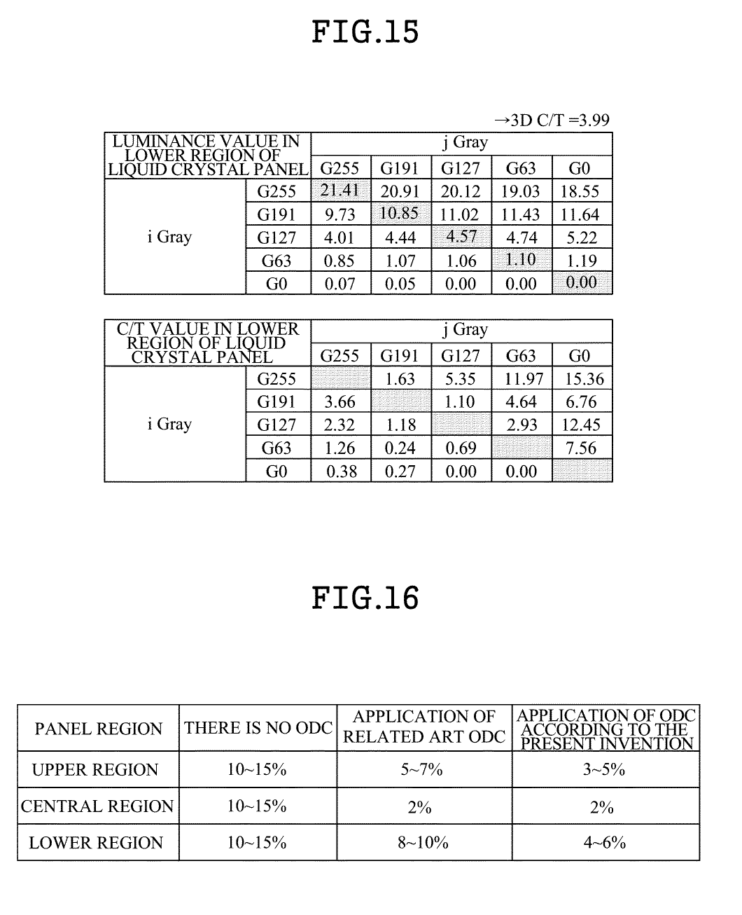

FIGS. 13 to 15 are tables showing the crosstalk measurement results by each luminance in the apparatus according to the embodiment of the present invention. FIG. 16 is a table comparing the crosstalk occurrence rate of the present invention with the crosstalk occurrence rate of the related art.

Referring to FIGS. 13 to 16, there is provided a test for verifying the lowered level of crosstalk occurrence on the entire display area through the use of overdriving controller 200 according to the embodiment of the present invention, and its driving method. The crosstalk occurrence rate for the 3D image is indicated through the test result.

The left-eye image with ‘i’ luminance (gray) and the right-eye image with ‘j’ luminance (gray) are alternately displayed on the liquid crystal panel 110; and the luminance values of the left-eye image and right-eye image viewed via the shutter glass are measured.

The crosstalk rate for each luminance is calculated by applying the measured luminance values of the left-eye image and right-eye image to the aforementioned equation 1; and the average of the crosstalk rate for each luminance may be shown in FIGS. 13 to 16. At this time, the luminance of the image displayed on the liquid crystal panel 110 may be changed by 64 gray unit (0gray [symbol] 63gray, 64 [symbol] 127, •••).

According to the measurement result, the average crosstalk rate in the central region of the liquid crystal panel 110 is 2.23; the average crosstalk rate in the upper region of the liquid crystal panel 110 is 3.70; and the average crosstalk rate in the lower region of the liquid crystal panel 110 is 3.99.

As shown in FIG. 16, in case of the related art, even though the overdriving is applied thereto, the crosstalk rate in the upper region of the liquid crystal panel is 5˜7%, and the crosstalk rate in the lower region of the liquid crystal panel is 8˜10%, whereby the picture quality of the 3D image becomes low.

In the meantime, if applying the overdriving controller 200 according to the embodiment of the present invention, and the local overdriving method to the LCD device, the crosstalk occurrence in the upper and lower regions as well as the central region on the liquid crystal panel is very low, that is, about 3˜6%, so that it is possible to improve the picture quality of the 3D image.

Accordingly, the apparatus and method for driving the LCD device according to the present invention enables to improve the picture quality of 3D image.

According to the apparatus and method for driving the LCD device according to the present invention, the display area of the liquid crystal panel 110 is divided into the plural local regions, and the overdriving (ODC) rate is differently applied to each of the plural location regions.

Also, the apparatus and method for driving the LCD device according to the present invention can realize the rapid response speed of liquid crystal by respectively applying different overdriving rates to the plural local regions obtained by dividing the display area of the liquid crystal panel 110.

Owing to the rapid response speed of liquid crystal, the crosstalk rate of 3D image is lowered considerably.

It will be apparent to those skilled in the art that various modifications and variations can be made in the present invention without departing from the spirit or scope of the inventions. Thus; it is intended that the present invention covers the modifications and variations of this invention provided they come within the scope of the appended claims and their equivalents.

What is claimed is:

1. An apparatus for driving an LCD device displaying 2D image, and 3D image through the use of shutter glass comprising:
a lookup table part including a 3D lookup table for generating 3D overdriving data to be reflected in 3D image data, and a 2D lookup table for generating 2D overdriving data to be reflected in 2D image data;
a lookup table selecting part for selecting the 2D lookup table or 3D lookup table provided from the lookup table part according to 2D or 3D mode input;
an ODC data generating part for generating the 2D overdriving data to be reflected in the 2D image, and the 3D overdriving data to be reflected in the 3D image according to 2D or 3D mode input; and
a shutter glass controlling part for controlling an operation of shutter glass so that a user recognizes an image displayed on a liquid crystal panel as the 3D image.

2. The apparatus according to claim 1, wherein the 3D lookup table comprises plural lookup tables to divide an entire display area into plural local regions and to apply the different lookup table values to the respective local regions.

3. The apparatus according to claim 1, wherein the lookup table selecting part provides the 2D lookup table to the ODC data generating part according to the 2D mode input, and provides the 3D lookup table to the ODC data generating part according to the 3D mode input.

4. The apparatus according to claim 1, wherein the ODC data generating part generates the 2D overdriving data for the 2D image through the use of 2D lookup table according to the 2D mode input, and provides the 3D overdriving data for the 3D image through the use of 3D lookup table according to the 3D mode input.

5. The apparatus according to claim 1, wherein the ODC data generating part generates a plurality of 3D overdriving data to divide an entire display area of liquid crystal panel into plural local regions and to apply an overdriving rate to each of the respective local regions.

6. The apparatus according to claim 1, wherein the ODC data generating part generates a plurality of 3D overdriving data for the 3D image by separately applying parameters for overshoot and undershoot, if the 3D image is displayed on the liquid crystal panel.

7. The apparatus according to claim 1, wherein the ODC data generating part divides the display area of the liquid crystal panel into a first block corresponding to a central region of the liquid crystal panel, a third block corresponding to upper and lower regions, and a second block corresponding to an intermediate region between the central region and the upper and lower regions; and generates a plurality of 3D overdriving data so as to apply the different overdriving rates to the respective first to third blocks.

8. The apparatus according to claim 7, wherein the overdriving rate is set by the ODC data generating part in such a way that the overdriving rate applied to the upper/lower region is larger than the overdriving rate applied to the central region.

9. A method for driving an LCD device displaying 2D image and 3D image through the use of shutter glass comprising:
generating 2D overdriving data for the 2D image through the use of 2D lookup table, or generating 3D overdriving data for the 3D image through the use of 3D lookup table, according to 2D mode or 3D mode input;
reflecting the 2D overdriving data or 3D overdriving data in image data aligned by each frame unit; and
displaying the 2D image or 3D image by supplying a liquid crystal panel with an analog data signal according to the image data in which the 2D overdriving data or 3D overdriving data is reflected.

10. The method according to 9, wherein the 3D image is displayed by dividing a display area of the liquid crystal panel into plural local regions, and applying the different overdriving rates to the respective local regions.
